(19) United States
(12) Patent Application Publication
(10) Pub. No.: US 2015/0343703 A1
(43) Pub. Date: Dec. 3, 2015

(54) METHOD FOR MANUFACTURING BASKETBALL

(71) Applicant: ANDREW WANG, TAIPEI CITY (TW)

(72) Inventor: ANDREW WANG, TAIPEI CITY (TW)

(21) Appl. No.: 14/291,206

(22) Filed: May 30, 2014

(51) Int. Cl. B29C 65/70

(52) U.S. Cl. CPC B29C 65/70; B29L 2031/54

(57) ABSTRACT

A method for manufacturing a basketball ensures quick manufacturing and high closeness between layers of the basketball. The method involves providing a vacuum mold with two mold halves, placing an inner cover in the mold halves, placing a fabric-covered bladder in one of the mold halves, closing the mold halves and making a space between the mold halves vacuum, so as to provide vacuum suction that forces the inner cover to be closely adhered to the fabric-covered bladder, thereby forming a middle bladder, placing a surface into the mold halves, placing the middle bladder into one of the mold halves, closing the mold halves and providing vacuum suction in the space again to make the surface closely adhered to the middle bladder, thereby forming a semi-product, placing the semi-product into a vulcanizing mold for heating and vulcanization, and obtaining the finalized basketball.

### BACKGROUND OF THE INVENTION

1. Technical Field

The present invention relates to a method for manufacturing a basketball, which accelerates the process for making basketballs and ensures layers forming the basketball bound with improved closeness.

2. Description of Related Art

A basketball is made by overlaying layers of rubber sheets. In the conventional manufacturing method, as shown in FIG. 1, a fabric-covered bladder is further adhesively covered by a layer rubber as an inner cover, so as to form a middle bladder, which is dried and adhesively covered by another layer of rubber as a surface, thereby forming a semi-product ball. Then the semi-product ball is dried and then heated in a vulcanizing mold for vulcanization, so as to vulcanize and integrate rubber of the inner cover and the surface as a whole, thereby finalizing a basketball. However, the technical approach as described above has the following defects:

(1) Manually adhering the inner cover and the surface is a time-consuming and effort consuming process, and therefore is less economical for mass production.

(2) After each of the adhesion steps, time is required for “drying,” making the overall manufacturing method time-consuming and less productive.

(3) Manually adhering the inner cover and the surface is not only time-consuming, but also less reliable, because human power may fail to achieve full closeness between the layers. As a result, air bubbles may exist between the inner cover and the fabric-covered bladder, and between the surface and the inner cover, in turn deteriorating the quality of the resultant basketball.

### SUMMARY OF THE INVENTION

In view of this, the present invention makes improvement to the prior art by providing a novel method for manufacturing a basketball, which includes: providing two mold halves that jointly form a vacuum mold; opening the mold halves; laying an inner cover in the mold halves; placing a fabric-covered bladder into the mold halves; drawing out air from space between the mold halves to make the space vacuum, thereby using vacuum suction to bind the inner cover and the fabric-covered bladder as a whole with high closeness and forming a middle bladder; taking out the middle bladder from the mold halves; laying a surface in the mold halves; placing the middle bladder back into the mold halves; making the space between the mold halves vacuum again to integrate the surface and the middle bladder together with high closeness into a semi-product; placing the semi-product into a vulcanizing mold; and heating the vulcanization, thereby obtaining the finalized basketball. By using the vacuum mold, the closeness between the fabric-covered bladder, the inner cover, and the surface is ensured, and the time required for making the basketball can be significantly reduced, in turn saving the time costs.

### BRIEF DESCRIPTION OF THE DRAWINGS

FIG. 1 is a flowchart of a conventional method for manufacturing a basketball.

FIG. 2 is a flowchart of a method for manufacturing a basketball according to the present invention.

FIG. 3 is a schematic drawing illustrating a middle bladder is formed by a vacuum mold according to the present invention.

FIG. 4 is a cross-sectional view of the vacuum mold with the middle bladder formed therein.

FIG. 5 is a schematic drawing illustrating a semi-product formed according to the present invention.

FIG. 6 is a cross-sectional view of the vacuum mold with the semi-product formed therein.

FIG. 7 is a cutaway perspective view of the semi-product of the present invention before vulcanization.

FIG. 8 is a perspective view of the vulcanized semi-product, namely the final product, of the present invention.

### DETAILED DESCRIPTION OF THE INVENTION

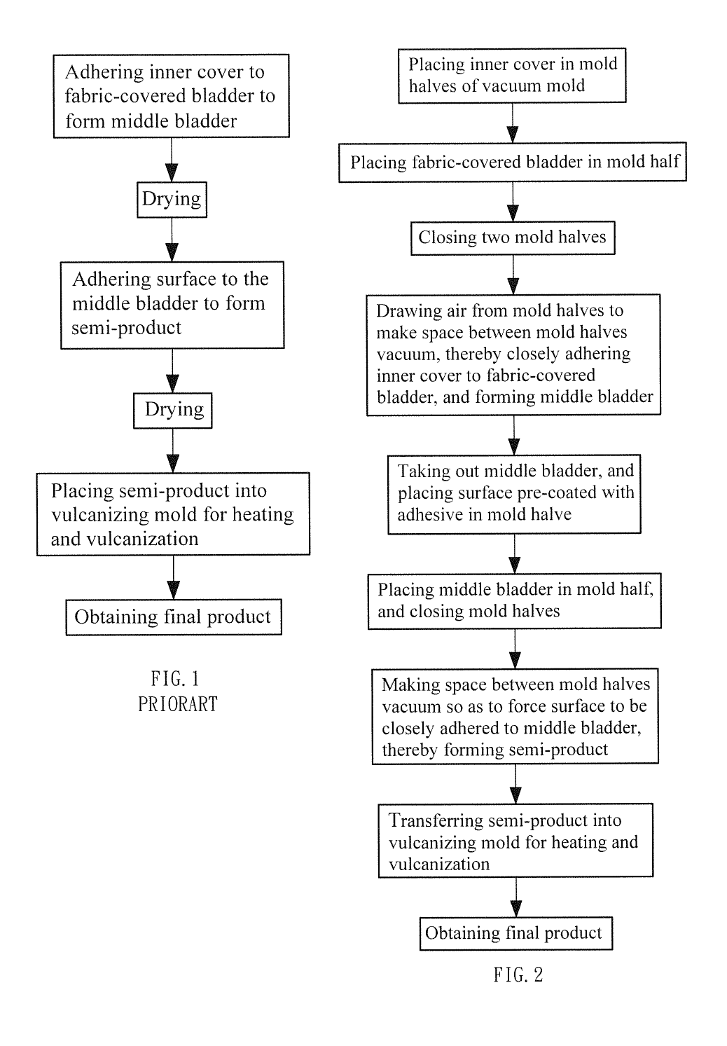

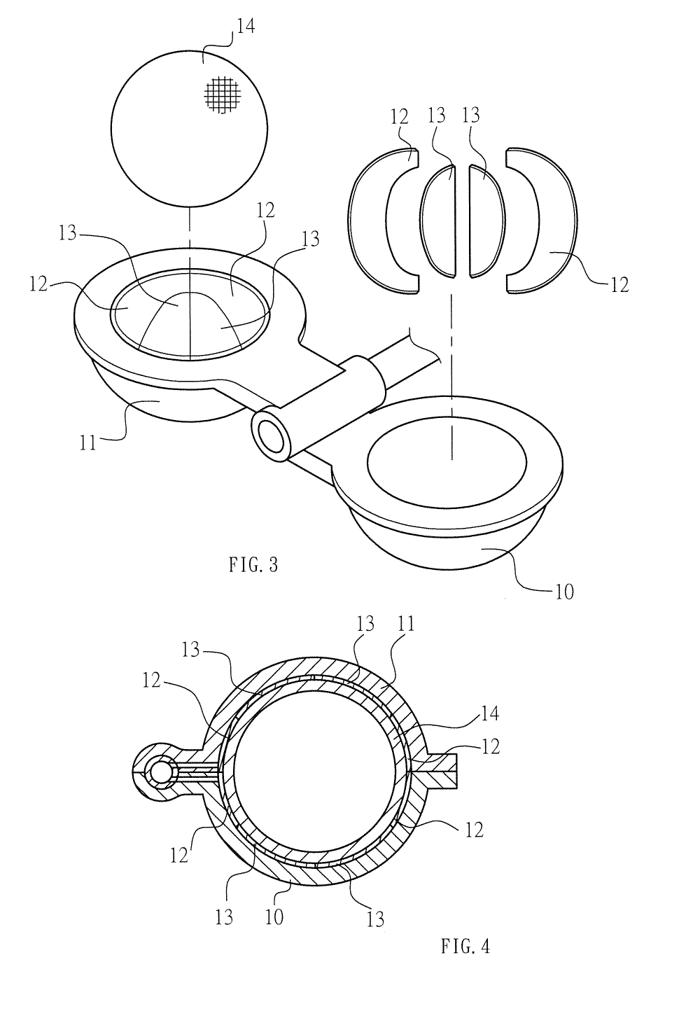

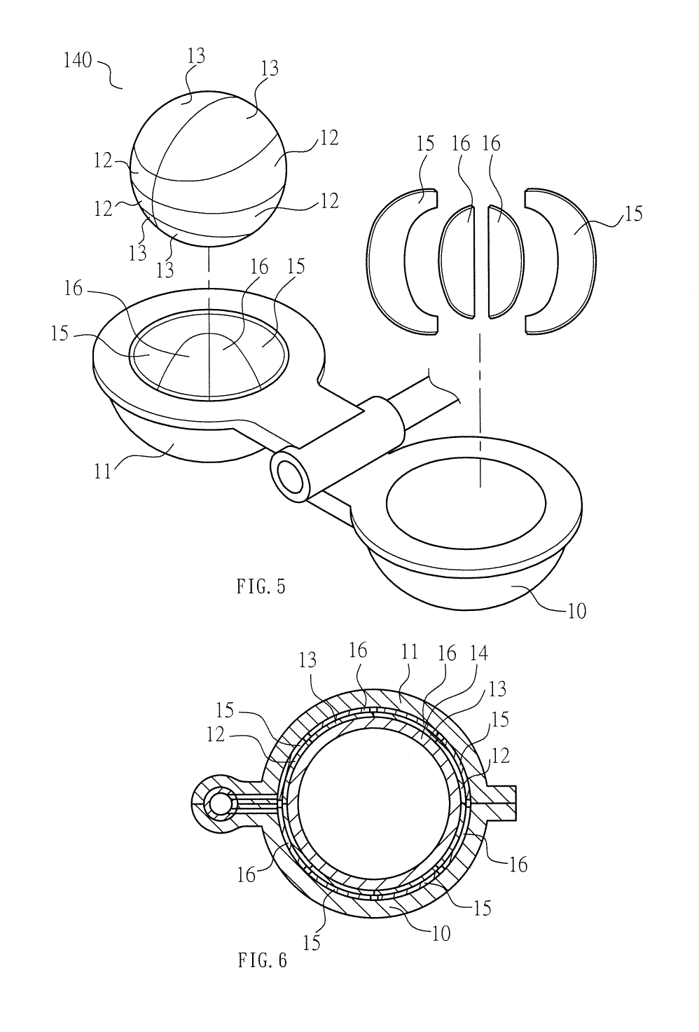

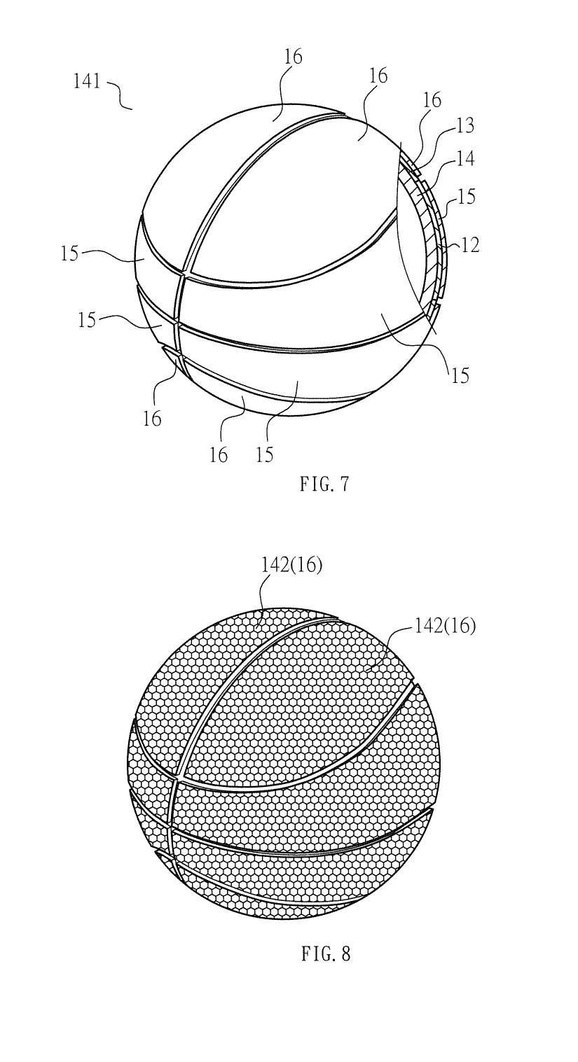

Please refer to FIGS. 2 through 8. According to the present invention, a vacuum mold comprising two mold halves 10, 11 is provided. The mold halves 10, 11 are open, and rubber-made inner cover pieces 12, 13 (as shown in FIG. 3) are placed therein. Then a hollow fabric-covered bladder 14 is placed into one said mold half 11. The mold halves 10, 11 are closed (as shown in FIG. 4), and the vacuum mold is activated to draw air out from the space between the mold halves 10, 11, thereby providing vacuum suction in the space to make the inner cover pieces 12, 13 closely attached to the fabric-covered bladder 14, forming into a middle bladder 140. The middle bladder 140 is then taken out, and rubber-made surface pieces 15, 16 are laid in the mold halves 10, 11 (as shown in FIG. 5). The surface pieces 15, 16 are pre-coated with adhesive. Then the middle bladder 140 is placed into one said mold half 11. The two mold halves 10, 11 can now be closed (as shown in FIG. 6), and after the vacuum bold is activated, the space between the mold halves 10, 11 becomes vacuum. Due to vacuum suction, the surface pieces 15, 16 are adhered to the inner cover pieces 12, 13 of the middle bladder 140 closely. Thereby, a semi-product of a basketball 141 (as shown in FIG. 7) is made. The semi-product 141 is afterward placed into a vulcanizing mold to undergo heating and vulcanization, so as to become a finalized basketball with a pattern 142 thereon (as shown in FIG. 8).

The technical scheme of the present invention provides the following benefits and advantages:

(1) When the inner cover pieces 12, 13 and the surface pieces 15, 16 are laid in the mold halves 10, 11, since the cavities of the mold halves 10, 11 define the working area, the placement can be quick and accurate. Then after the bladder is placed and the mold halves are closed, the “adhesion” can be easily achieved, so the process is time-saving, thereby reducing time costs.

(2) When the inner cover pieces 12, 13 are adhesively attached to the fabric-covered bladder 14, and when the surface pieces 15, 16 are adhesively attached to the middle bladder 140, the “vacuum suction” provided between the mold halves 10, 11 can expel any air bubbles between the inner cover pieces 12, 13 and the fabric-covered bladder 14, and between the surface pieces 15, 16 and the middle bladder 140. As a result, completely closeness is achieved, so the layers are closely bound to form a well-integrated basketball.

(3) Since air bubbles are unable to form between the layers, the resultant basketball is free from any irregular bulges and thus is perfectly round.

(4) The disclosed method use “vacuum suction” to eliminate the need of performing manual adhesion as required by the prior art, so as to achieve automatic and rapid adhesion, thereby accelerating the overall manufacturing process.

(5) Since the layers are bound with high closeness, when put into vulcanization, the semi-product can be well integrated as a whole final product.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for manufacturing a basketball, comprising the following steps: providing a vacuum mold that has two mold halves, lay a rubber-made inner cover in the mold halves, placing a fabric-covered bladder into one said mold half, closing the mold halves, activating the vacuum mold to draw air out from a space between the mold halves and thereby provide vacuum suction in the space so as to force the inner cover to be closely adhered to the fabric-covered bladder and form a middle bladder; taking the middle bladder out from the vacuum mold; laying a rubber-made surface in the mold halves, wherein the surface is pre-coated with adhesive, and placing the middle bladder into one said mold half, closing the two mold halves, activating the vacuum mold to provide vacuum suction and force the surface to be closely adhered to the inner cover on the middle bladder, so as to form a semi-product, and placing the semi-product into a vulcanizing mold for heating and vulcanization, thereby obtaining the finalized basketball.
